(19) United States
(12) Patent Application Publication
(10) Pub. No.: US 2020/0029669 A1
(43) Pub. Date: Jan. 30, 2020

(54) DEVICE FOR TREATING LICE INFESTATION

(71) Applicants: Arik ESICOVICH, Ganot Hadar (IL); Moshe RUBINO, Ramat Gan (IL); Yacov BIOFCIC, Petach Tikva (IL)

(72) Inventors: Arik ESICOVICH, Ganot Hadar (IL); Moshe RUBINO, Ramat Gan (IL); Yacov BIOFCIC, Petach Tikva (IL)

(21) Appl. No.: 16/491,344

(22) PCT Filed: Feb. 8, 2018
(86) PCT No.: PCT/IL2018/050141

§ 371 Date: Sep. 5, 2019

(30) Foreign Application Priority Data
Mar. 7, 2017 (IL) 251002

(51) Int. Cl. A45D 24/10; A01M 3/00; A45D 24/30

(52) U.S. Cl. CPC A45D 24/10; A45D 2200/207; A45D 24/30; A01M 3/007

(57) ABSTRACT

The present invention relates to a comb device for treating lice infestation, comprising: a) heat conducive teeth in which their extremity form a fine-tooth comb; b) a heating source adapted for heating said teeth; and c) a vibration motor adapted for vibrating said teeth in a multi-axis manner, wherein said heating source and said vibration motor are configured to work together.

### FIELD OF THE INVENTION

The present invention relates to the field of hygiene products. More particularly, the invention relates to a device for treating pediculosis, specially adapted for removing parasites present in hair, such as lice, nits, nymphs or similar.

### BACKGROUND OF THE INVENTION

The phenomenon of head lice infection is a global scale problem. The phenomenon is extremely common among children and can cause scratching, allergic reaction to the lice's stings, skin bacterial or fungus infection caused as a result of skin injury and introducing pollutants.

Nowadays, there is a wide range of solutions known in the art aiming to deal with lice infestation starting from the standard combs for removing lice which are caught between the comb teeth when they are passed through the hair. This approach tends to be inadequate in removing lice eggs which remain attached to the hair.

Another well-known method for treatment of lice infestation is the use of chemicals. A drawback of this method is the tendency of lice to build up resistance to the active ingredients in these chemicals, causing the reducing of their effectiveness. Moreover, accumulation of these chemicals in the body is health hazard, especially for children.

Natural ingredients have also been used to treat lice infestation, including the use of aromatic oils. A significant drawback for the use of these materials is the difficulty might be in removing and cleaning them from the hair after the use in addition to their tendency to cause severe irritation of the scalp in young children.

Other well-known approached for destruction of lice is an electronic device marked under the tradename “Robi-combi”. A metal comb device equipped with a charged capacitor is passed through the hair and discharged through the lice causing their destruction. This device is ineffective against lice eggs.

The art has so far failed to provide an efficient mechanical solution that not only is pain free while using, but also gives high results in the extermination of lice, nits and nymphs as well. It is therefore clear that it would be highly desirable to provide such a device which may ensure a high degree of effectiveness in treating lice infestation.

It is a purpose of the present invention to provide a comb device for treating lice infestation in an efficient manner and while alleviate the pain of combing hair for pain-free and ease use.

It is yet another purpose of the present invention to provide a safe device with high effectiveness for lice, nymphs and lice eggs destruction.

Further purposes and advantages of this invention will appear as the description proceeds.

### SUMMARY OF THE INVENTION

The present invention relates to a comb device for treating lice infestation, comprising:
heat conducive teeth in which their extremity form a fine-tooth comb;
a heating source adapted for heating said teeth; and
a vibration motor adapted for vibrating said teeth in a multi-axis manner, wherein said heating source and said vibration motor are configured to work together (e.g., they may work simultaneously or according to other operation modes).

According to an embodiment of the invention, the heating source is adapted to heat the extremity of the teeth to the range of 39-45 Celsius degrees (or higher temperature range based on user safety regulations).

According to an embodiment of the invention, the device further comprises a controller that enable to control the heating level produced by the heating source and thereby to control the temperature of the teeth.

According to an embodiment of the invention, a controller adapted to control the vibration intensity produced by the vibration motor.

According to an embodiment of the invention, the heating source and the vibration motor are configured to work together simultaneously.

In another aspect, the present invention relates to a method for treating lice infestation, comprising:
providing heat conducive teeth in which their extremity form a fine-tooth comb;
heating said teeth by using a heating source; and
vibrating said heated teeth in a multi-axis manner by a vibration motor.

All the above and other characteristics and advantages of the invention will be further understood through the following illustrative and non-limitative description of embodiments thereof, with reference to the appended drawings.

### BRIEF DESCRIPTION OF THE DRAWINGS

In the drawings:

FIG. 1 schematically illustrates an exemplary external form of a comb device, according to one embodiment of the present invention;

FIG. 2 schematically illustrates an internal view of the comb device of FIG. 1, according to an embodiment of the present invention; and

FIG. 3 schematically illustrates a different angle view of FIG. 2.

### DETAILED DESCRIPTION OF EMBODIMENTS OF THE INVENTION

Reference will now be made to an embodiment of the present invention, examples of which are illustrated in the accompanying figures for purposes of illustration only. One skilled in the art will readily recognize from the following description that alternative embodiments of the structures and methods illustrated herein may be employed, mutatis mutandis, without departing from the principles of claimed invention.

Generally speaking, the device of the invention designed to effectively exterminate nits, nymphs and lice from a person head. The device comprise thick comb accommodate to be heated (e.g., by a heating source) and vibrated (e.g., by a vibration unit) resulting a comb device treating lice eggs and lice using the ultimate combination of those two elements (i.e., heat and vibration) working together.

Moreover, as oppose to the vibration combs known in the art, which only capable of one axis movement, the comb device of the invention designed to enable multi-axis movement (e.g., up-down and sideways) resulting a significant better coverage of nits, nymphs and lice destruction.

It is known that lice cannot survive extreme heat, in particular head lice needs a temperature under 38 Celsius degrees as a basic surviving condition. As to nits, a temperature higher than 38 Celsius degrees may cause destruction for the developed nymphs inside. In addition to the heat as a destructive factor, the vibration causes physical irreparable damage to the eggshell resulting their mortality.

Therefore, the comb device of the present invention designed to reach a temperature that is higher than 38 Celsius, e.g., the temperature of 42 Celsius degrees, at the teeth extremity in combination of unique multi-axis vibration (e.g., at least two-axis vibration) to efficiency exterminate eggs, nymphs and adult lice. It is clear that said temperature of the teeth extremity is not limited to 42 Celsius degrees. However, since the teeth extremity may contact a person's skin (e.g., the scalp of a patient), the temperature shouldn't exceed any known risk skin burn temperature (based on users age/exposure time) for a safe use and prevent a potential health hazards for the patient. By limiting the temperature, the comb device may safely be applied to hair nearest the skin where viable eggs are most abundant. For other non-human applications or usage, a temperature higher than 42 Celsius degrees might be used.

In the illustrative embodiments showed below, the device consist of: a casing, heat conducive teeth or bristles (e.g., made of metallic material) that form a fine-tooth comb, a heating source, a controller such as a proportional integral derivative (PID) controller, rotated vibration motor, a power output and Solid State Relay (SSR) PWM (Pulse width modulation) of thermos/mechanics. The SSR designed to switch DC power in order to drive the elements of the device, such as the heating source, the vibration motor and the controller.

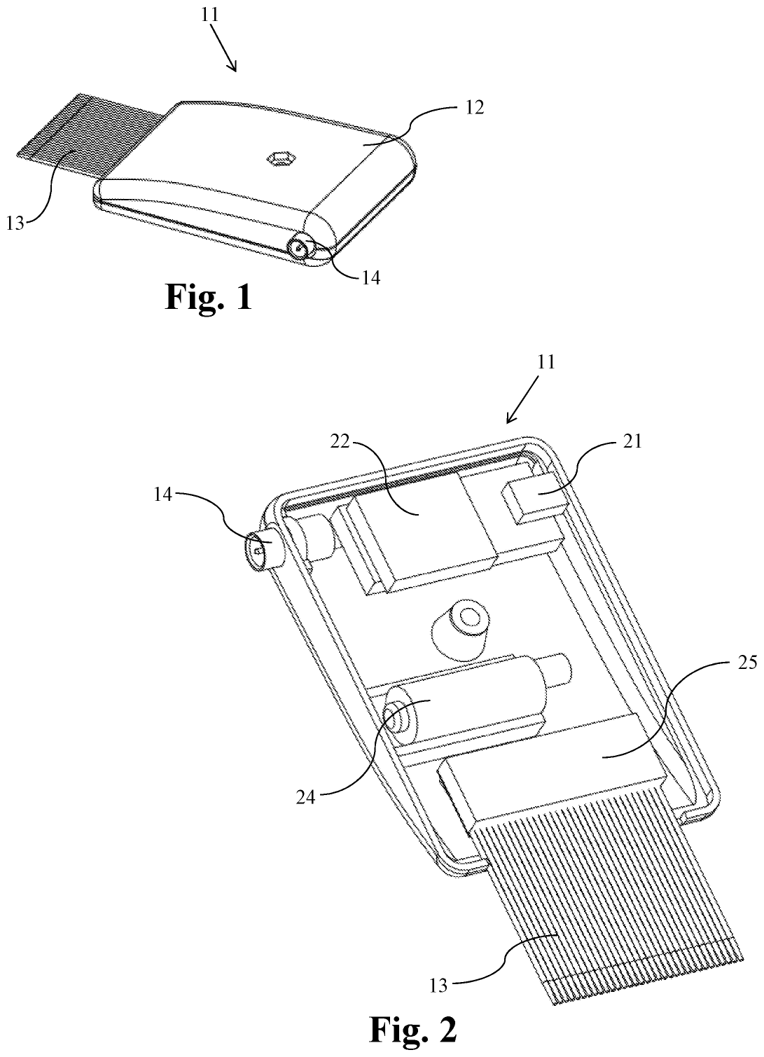

Referring to FIG. 1, an external view of a comb device 11 is illustrated, according to an exemplary embodiment of the invention. Comb device 11 comprises crowded metallic teeth 13 that are adapted for the combing of a person's hair in a way that can be used to remove macroscopic parasites while combing (e.g., teeth 13 forms a fine-toothed comb), a casing 12 and a power outlet 14. It is clear that the comb device 11 is not limited to the shape illustrated in FIG. 1 and can be of any shape, size and material with the require adjustments.

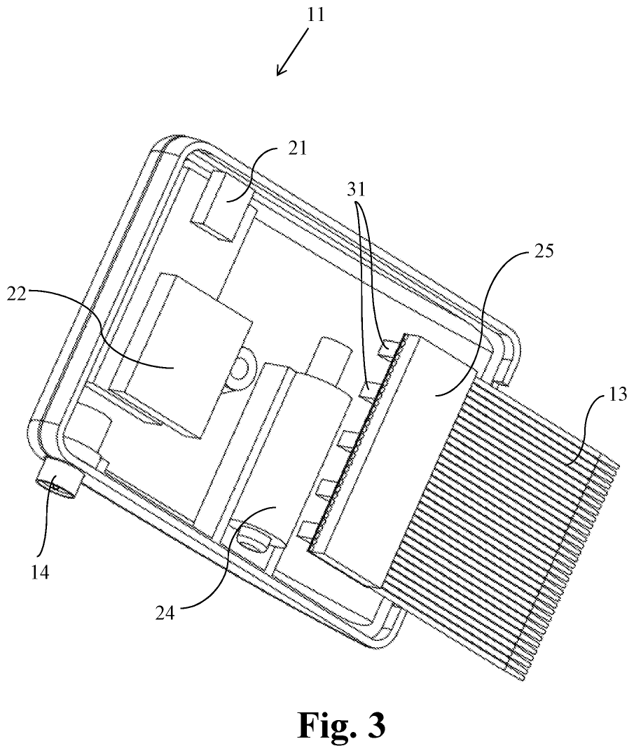

FIGS. 2 and 3 schematically illustrate an internal view of the comb device 11, according to an embodiment of the invention. Comb device 11 comprises a vibration motor 24 and a heating source 31. Teeth 13 attached at one end to a teeth base 25 which is heated by heating source 31. Vibration motor 24 (e.g., Vibration motor type N60) generates vibration that causes teeth 13 to vibrate in a multi-axis manner (e.g., two-axis movement of teeth 13). FIGS. 2 and 2 also shown power outlet 14 (e.g. DC power socket 8 mm), a controller 21 that can be used to control the operation modes of comb device 11. For example, controller 21 may control the temperature of teeth 13 for the set range as well as the vibration intensity. For example, controller 21 can be a PID controller such as Arduino Nano by Arduino®. Comb device 11 may further include a SSR 22 (e.g., SSR Omron G3MB-202P by Omron Electronics LLC).

According to another embodiment of the invention, comb device 11 may comprise two controllers 21, one controller adapted for controlling the temperature and the other for controlling the vibration.

FIG. 3 illustrates a different angle view of FIG. 2 showing also heating apparatus 31. Heating apparatus 31 heat teeth base 25 to the high temperature of 50 Celsius degrees. Teeth 13 can be made of metallic heat conductive material, so the temperature at the extremity of teeth 13 (i.e., the portion of teeth 13 that may touch the person's skin) should be higher than 38 Celsius degrees (e.g., 42 Celsius degrees). It is clear that the gradient temperature of teeth 13 is only an example and depends, inter alia, on the teeth material and its heat conductivity, the teeth length, thickness, etc. Those parameters, among others, will determine the temperature of teeth base 25 in order to reach the effective temperature at the extremity of teeth 13 to the range of 39-45 Celsius degrees or different temperature range (based on user safety regulations and user age/exposure time).

The multi-axis movement of teeth 13 may gain two significant advantages:
a. Causing terminal destruction to the nits shell preventing them from hatching. This multi-axis movement was found effective to nits shell damage, rather than using just a single axis movement.
b. Alleviating the pain of combing hair with a thick comb.

Another advantage of the comb device of the invention is that it allows treating the hair while the hair is wet, or after using chemicals materials such as hair conditioner without derogate the comb device efficiency of exterminates nits and lice.

Although embodiments of the invention have been described by way of illustration, it will be understood that the invention may be carried out with many variations, modifications, and adaptations, without exceeding the scope of the claims.

1. A comb device for treating lice infestation, comprising:
a) heat conducive teeth in which their extremity form a fine-tooth comb;
b) a heating source adapted for heating the extremity of said teeth; and
c) a vibration motor adapted for vibrating said teeth in a multi-axis manner in order to cause physical damage to the eggshell of the lice's nits, wherein said heating source and said vibration unit are configured to work together.

2. The device according to claim 1, in which the heating source is adapted to heat the extremity of the teeth to a temperature higher than 39 Celsius degrees and up to the limited temperature set by user safety regulations.

3. The device according to claim 1, further comprises a controller enable to control the heating level produced by the heating source and thereby to control the temperature of the extremity of the heat-conducive teeth.

4. The device according to claim 3, in which a controller adapted to control the vibration intensity produced by the vibration motor.

5. The device according to claim 1, in which the heating source and the vibration motor are configured to work together simultaneously.

6. A method for treating lice infestation, comprising:
a) providing heat conducive teeth in which their extremity form a fine-tooth comb;
b) heating the extremity of said teeth by using a heating source; and
c) vibrating said heated teeth in a multi-axis manner by a vibration motor for causing physical damage to the eggshell of the lice's nits, wherein said vibration motor and said heating source are configured to work together simultaneously.
